(19) United States
(12) Patent Application Publication
(10) Pub. No.: US 2011/0261586 A1
(43) Pub. Date: Oct. 27, 2011

(54) LIGHT GUIDE SYSTEM, AND REFLECTOR FOR CONTROLLING OUT-COUPLING OF LIGHT

(75) Inventors: Cornelis Wilhelmus Kwisthout, Eindhoven (NL); Theodorus Franciscus Emilius Maria Overes, Eindhoven (NL); Petrus Gerardus Josephus Maria Nuijens, Eindhoven (NL)

(73) Assignee: KONINKLIJKE PHILIPS ELECTRONICS N.V., EINDOVEN (NL)

(21) Appl. No.: 13/141,805

(22) PCT Filed: Dec. 16, 2009
(86) PCT No.: PCT/IB2009/055777

§ 371 Date: Jun. 24, 2011

(30) Foreign Application Priority Data
Dec. 23, 2008 (EP) 08172705.9

(51) Int. Cl. F21V 7/22

(52) U.S. Cl. 362/607; 362/606

(57) ABSTRACT

A light guide system (20) for controlling out-coupling of light is provided. The light guide system comprises a light guide (21) configured to receive ambient light from at least one light source (26), and emit spread ambient light from a surface thereon. The light guide system further comprises a reflector (22) provided with a number of protrusions (23). In use, the reflector (22) and the light guide (21) are attached together. An advantage of this embodiment is that a uniform light -radiating surface using a light guide is enabled.

### FIELD OF THE INVENTION

The present invention pertains to the field of light guides, and particularly to a light guide system for enabling uniform out-coupling of light.

### BACKGROUND OF THE INVENTION

Display systems for enhanced viewing experience when watching video shown on a display device, such as a TV, by using light sources for projecting ambient light are known in the art.

A particularly interesting application is projecting the ambient light towards a viewer.

The benefits of providing ambient light in general includes: a deeper and more immersive viewing experience, improved color, contrast and detail for best picture quality, and reduced eye strain for more relaxed viewing. Different advantages of backlighting require different settings of the backlighting system. Reduced eye strain may require slow changing colors and a more or less fixed brightness while more immersive viewing experience may require an extension of the screen content i.e. the same brightness changes with the same speed as the screen content.

Typically, the display device is a flat TV. The display device may be provided with controllable light sources, such as Light Emitting Diodes (LEDs), located adjacent to a display area or screen in use displaying images or video content. In use, the light sources may emit ambient light towards a user in front of the display device.

However, a drawback of using LEDs to display ambient light is that each LED may be regarded as a point source. To enable a uniform, diffusely emitting light surface for the user from light originating from multiple LEDs, a light path is required to spread the light evenly.

A known method to create the required light path in an ambient light display system is by using a light guide. The method works as follows. Light from the light sources is coupled into an optically transparent material and transported over a certain distance so that it may spread and mix with the other light sources as required. Typical applications are LED backlight systems, various indicator lights and/or surfaces on electronic equipment. Accordingly, almost all the light will couple out at the end of the light guide.

In order to couple out the light from the surface of the light guide, i.e. perpendicular to the direction of the light, various methods exist. One way is to structure the surface of the light guide that needs to radiate the light, for example using foils, sandblasting, micro prisms or textures on one side. This method has several disadvantages. First of all, these structures, even when mechanically diffuse, do not necessarily result in ideal diffuse light sources with a dominant direction perpendicular to the surface of the light guide. Instead, most of the light will keep the dominant direction of the light in the light guide, meaning that it is best visible when observed at an angle to the light guide, looking towards the sources of the light. Furthermore, the diffuse surface emits the light in all directions, i.e. 360 degrees, however with a required perpendicular direction as described above, meaning that some of the light is emitted to the wrong side of the light guide and is lost, unless a mirror is used. These effects lower the optical efficiency of the ambient light display system. Finally, the light that couples out from the light guide in the desired direction will not be uniform if a constant structure is applied. In such case most of the light couples out at the beginning of the structure. For small surfaces this might hardly be visible.

A known method for creating a uniform light surface when using a light guide is by using a non-uniform out-coupling structure. Basically this means that some of the light couples out at the beginning of the structure so less light is available at the next point of out-coupling. This is compensated by gradually increasing the structure density along the extension of the light guide to maintain a constant emission, or coupling out, of ambient light. In this way the light that is being emitted per square mm may be kept constant.

The non-uniform out-coupling structure may e.g. be a dotted pattern with smaller dots at the beginning of the light surface and bigger dots towards the end of the light surface. In principle sandblasted dots could be used but these are associated with the same disadvantages as described before with reference to the direction of the light, i.e. emitting both at the wanted side and at the wrong side. Practical experiments have shown that the best results are achieved utilizing a white diffuse paint. Since the paint is opaque all light goes in the wanted direction. Furthermore, the dominant light direction is much more perpendicular to the surface of the light guide. For example white paint couples out the light much more like a light source at that position would do, meaning that the out-coupled light direction is essentially perpendicular to the light guide. By utilizing sandblasted dots the light is coupled out at an angle, i.e. not perpendicularly, such as if a light source was used emitting ambient light at the angle with reference to the surface of the out-coupling structure. FIGS. 1a to 1c illustrates a light guide system according to prior art. FIG. 1a is a top view, FIG. 1b illustrates a side view, and FIG. 1c is a bottom view of a schematic illustration of the light guide system. FIGS. 1a to 1c illustrates a light guide 11 configured to receive light from at least one light source 16. At a distance from the light guide is a diffuser 14 provided for diffusing light coupled out of the light guide. Moreover, dots 23 forming a dot pattern, as discussed above, are provided onto the bottom side of the light guide 11.

The light guide system of FIG. 1a to 1c has a few disadvantages. A first drawback is that a dot pattern needs to be applied on the surface of the light guide. As previously mentioned this may be performed using printing techniques or foils. This requires additional processing of the light guides, which might not be straightforward since the light guides may have complicated shapes depending on the application.

A second drawback is that the dot pattern still allows light to pass through to the wrong side. This is due to the fact that the dot pattern does not create a fully uniform surface light source since basically all dots become point light sources. To solve this issue, an additional diffuser could be applied at the out-coupling side of the light guide, with an air gap between both components, wherein the air gap prevents out-coupling of light. The diffuser will also reflect light back into the light guide and part of this light passes in between the dots and is lost at the wrong side.

A third drawback is that the light guide basically may not be touched since every contact results in a distortion whereby light is coupled out and is lost. This makes integration of the light guide in the total mechanics a complex challenge.

Hence, an improved light guide system allowing for uniform out-coupling of light, improved visual appearance, increased flexibility, or cost-effectiveness would be advantageous.

Accordingly, the present invention preferably seeks to mitigate, alleviate or eliminate one or more of the above-identified deficiencies in the art and disadvantages singly or in any combination and solves at least the above-mentioned problems by providing a light guide system, and reflector according to the appended patent claims.

An idea according to some embodiments is to provide a reflector being configured with protrusions replacing the dot pattern of the light guide of prior art.

In an aspect of the invention a light guide system for controlling out-coupling of light from a light guide is provided. The light guide system comprises a light guide configured to receive light from at least one light source, and emit spread light from a surface thereon. The light guide system further comprises a reflector provided with a number of protrusions, wherein at least one protrusion of the reflector is in optical contact with the light guide, in use.

In another aspect of the invention a reflector is provided. The reflector comprises a number of protrusions forming a pattern of increasing distortion along at least a part of its extension thereof, wherein at least one protrusion of the reflector when in optical contact with a light guide, is configured to couple out light travelling in the light guide.

An advantage of the light guide system according to some embodiments is that the out-coupled light will be uniform along with the extension of the light guide, thus forming a uniform light-radiating surface along the light guide.

Moreover, the light guide system and reflector according to some embodiments allows for connection to or installation in e.g. a display device without touching the light guide during connection or installation. This drastically reduces the impairing distortions formed when handling the light guide, and thus improves the controlled out-coupling of light from the light guide.

Furthermore, the reflector according to some embodiments is configured to reflect light out-coupled at the wrong side of the light guide back through the light guide. Accordingly, the reflector according to some embodiments improves the light efficiency since no light is unnecessarily lost due to out-coupling of light at the wrong side of the light guide.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1a is a top view of a schematic illustration of an ambient light display system according to prior art;

FIG. 1b is a side view of a schematic illustration of an ambient light display system according to prior art;

FIG. 1c is a bottom view of a schematic illustration of an ambient light display system according to prior art; and

FIG. 2a is a top view of a light guide system according to an embodiment;

FIG. 2b is a side view of a light guide system according to an embodiment; and

FIG. 2c is a bottom view of a light guide system according to an embodiment.

### DESCRIPTION OF EMBODIMENTS

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

The following description focuses on embodiments of the present invention applicable to a light guide system.

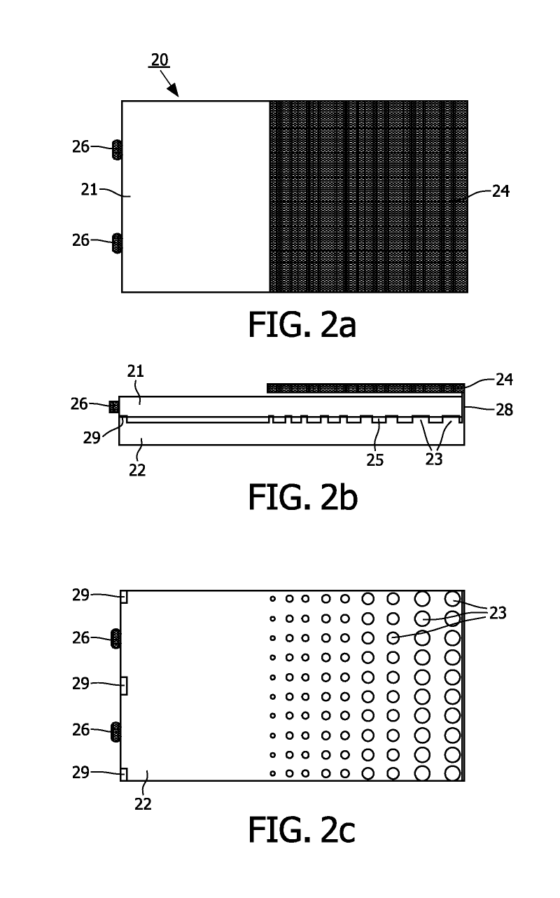

In an embodiment, according to FIG. 2, a light guide system 20 for providing ambient light is provided. The light guide system comprises a light guide 21 configured to receive ambient light from at least one light source 26, and emit spread ambient light from a surface thereon. The light guide system further comprises a reflector 22, in at least a portion thereof, provided with a number of protrusions 23 or objects when in optical contact with the light guide enables coupling out of the ambient light. In use, the reflector 22 and the light guide 21 are attached together, e.g. using commonly known methods. For example the reflector may be attached to the light guide e.g. by using adhesives, glue, or melting the reflector and light guide together. In order to provide out-coupling of light the reflector, or at least a protrusion thereof, and the light guide has to be in optical contact.

In an embodiment, the number of protrusions forms a pattern on the surface of the reflector. The pattern of the reflector functions to couple out ambient light of the light guide, in use.

The construction of the pattern, i.e. the relative positioning of the protrusions, as well the configuration of each protrusion in terms of design, size, etc. will have impact on the optical characteristics when the reflector is attached to the light guide. Thus, depending on the desired out-coupling of light from the light guide the configuration of the protrusion pattern may be changed in order to obtain the desired effect. For almost every desired out-coupling of light from the light guide a protrusion pattern may be calculated. For example, it is possible to provide a pattern having a gradual increasing distortion by means of gradually increased size of the protrusions along with the extension of the reflector. In other words this means that the size, e.g. the width of the protrusions increases with increasing distance from the light source. This is illustrated in FIG. 2.

In another embodiment, the number of protrusions per area unit is increased along with the extension of the reflector. Also a combination of gradually increasing sizes and gradually increasing number of protrusions may be utilized in order to obtain the desired coupling out of light along the light guide.

In an embodiment, the reflector pattern comprises at least one peak forming a protrusion in the reflector surface.

However, it should be appreciated that other protrusion shapes than peaks may be utilized, such as elongated shapes having a height enabling optical contact with the light guide in use. The width and length of such elongated shape may be determined based on the desired out-coupling of light from the light guide.

In an embodiment, the size of the protrusions of the reflector pattern is increased along with the length of the light guide. In other words this means that the size, e.g. the width of the protrusions increases with increasing distance to the light source. This is illustrated in FIG. 2. An advantage of this embodiment is that the out-coupled light will be uniform along with the extension of the light guide, thus forming a uniform light-radiating surface along the light guide.

In an embodiment, at least one protrusion has the form of a peak or is conically shaped. The reflector pattern thus comprises at least one peak forming a protrusion in the reflector surface.

In an embodiment, the areas 25 or air gaps, which are indicated in FIG. 2 of the reflector located in between the protrusions act to pass wrongly directed ambient light to the reflector 22, thus preventing the ambient light of exiting the light guide at the wrong side. Since the reflector is not in optical contact with the light guide at the location of each area 25 no light will be coupled out at these locations, since the ambient light travelling in the light guide will encounter no distortion. However, some light may still be incident on a reflector area 25, due to internal reflection in the light guide or light being reflected from a diffuser 24, travelling through the light guide and then encountering the reflector area 25. This ambient light incident on each reflector area 25 is then reflected back through the light guide again. Accordingly, the function of the air gap area 25 is at least two-fold, disabling out-coupling of guided light, and reflecting light escaping at the wrong side of the light guide incident on the reflector area 25. This reflected ambient light then coupled out of the light guide at the side of the light guide opposite the side of the reflector. Accordingly, light reflected from the reflector area 25 may not be guided anymore through the light guide, but can only pass through the light guide again.

In an embodiment, the reflector areas 25 act as a diffuse reflector, meaning that it will reflect incident light in all directions such that only a part of the incident light will have the same angle after reflection.

As such, the areas 25 in between the protrusions increase the efficiency of the light guide system by reflecting ambient light that would, if the reflector would not be attached as in prior art, exit the system at the wrong side of the light guide. Accordingly, the reflector according to some embodiments prevents ambient light to be coupled out on the wrong side of the light guide.

Using the reflector 22 attached to the light guide, the light guide system may be connected to a display device, such as a TV screen, without having to touch the light guide, which is essential not to add impairing distortions on the light guide surface. Accordingly, since the pattern is part of the reflector, the reflector may be used to fixate the light guide system according to some embodiments e.g. to a display device. This embodiment drastically reduces the risk of adding impairing distortions due to handling of a light guide of prior art provided with a dot pattern, when connecting such light guide to e.g. a display device.

In an embodiment the light guide system further comprises a diffuse layer 24 or a diffuser. The diffuser is provided at a distance from the side of the light guide opposite to the side at which the reflector is attached. The distance enables light travelling inside the light guide not to be coupled out due to contact made with the diffuser. Instead, the light incident on the diffuser originates from light coupled out via the protrusions 23 of the reflector or reflected light from the reflector areas 25.

In an embodiment the reflector is provided with a white paint enabling incident light to be reflected using areas 25 and/or coupled out using the protrusions 23. White paint allows for a diffuse reflection of incident light.

In an embodiment the reflector is made of a plastic material, such as any plastic material.

In an embodiment, the reflector including the reflector pattern is created using injection moulding.

The reflector according to some embodiments may also be provided with a foil as long as the pattern of protrusions are in optical contact with the light guide and the areas 25 in between the protrusions are not in optical contact with the light guide, in use.

In an embodiment the reflector is provided with a foil that is white diffuse and that an adhesive is provided on the foil at the positions of only the protrusions of the reflector for attaching the protrusion pattern to the light guide. In this way only the protrusions are in optical contact with the light guide in use, and the risk for excessive use of glue, potentially impairing the distortion by also connecting the areas 25 to the light guide is thus drastically reduced.

In an embodiment the plastic material of the reflector acts as a diffuse reflector for the light spill in the small areas 25 between the small peaks.

In an embodiment the plastic material is a white plastic material.

The more diffuse the surface of reflector protrusions is, the better the distortions resemble a small light source as if it was positioned directly behind the diffuser at the position of the protrusion. Hence, a more diffuse reflector surface will enable a more uniform out-coupling of light.

In an embodiment the reflector is attached to the light guide by thermal sealing, i.e. by partly melting the reflector and light guide together at selected points. In another embodiment, the reflector and the light guide is attached utilizing a glue layer provided on the protrusions and gluing the reflector and light guide together. Care should be taken that the glue does not connect the area or space between the protrusions to the light guide, since otherwise an optical connection is formed. Should the areas be glued together with the light guide, the connection would form a distortion affecting the coupling out of light.

In an embodiment, when attached together the light guide and the reflector are fixated against each other such that the protrusions of the reflector interferes with the optical path of light travelling through the light guide. In this way each protrusion acts as an ambient light out-coupling element. In other words, the optical path direction of light travelling through the light guide is changed when the protrusions and/or indentations are encountered.

According to an embodiment, each component of the light guide system may be produced using standard methods known in industry.

In an embodiment, the light guide has a flat shape, e.g. a rectangular shape with a certain height. Accordingly, the reflector may also be configured in a rectangular shape, having varying height depending on the protrusions along its. The areas 25 of the reflector may form an essentially flat surface, which in use will be essentially parallel to the flat surface of the light guide.

The difference in height between the flat surface comprising the areas 25 and the protrusions may be very small. A requirement of the height difference is that it only needs to guarantee that both surfaces, i.e. the areas 25 and the flat surface of the light guide, are not optically connected between the protrusions, since otherwise the complete surface of the reflector would act as a homogeneous light out-coupling structure. This would be disadvantageous since the dots formed by the protrusions would become bigger and ultimately even connect so that an entire reflector surface would be in optical contact with the light guide. Such a homogeneous distortion would result in an inhomogeneous and non-uniform out-coupling of light.

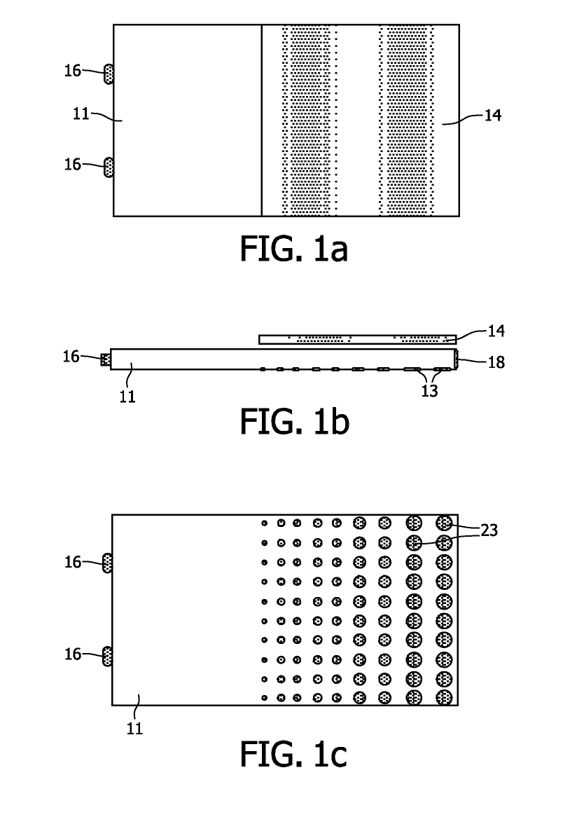

In an embodiment the end of the reflector may comprise an alignment protrusion 28 having a larger height than the other protrusions of the reflector. This alignment protrusion 28 may be utilized for aligning the light guide horizontally, and to stop the light guide from further movement in relation to the reflector. It may be observed from FIG. 2 that the alignment protrusion also forms a spacer to the diffuser. The alignment protrusion 28, also referred to as the horizontal alignment protrusion, of the reflector may replace the mirror 18 according to the prior art system of FIG. 1. This will result in more ambient light being coupled out at the end of the light guide compared to a mirror, which ideally only reflects the light back into the light guide.

In an embodiment, there is provided at a first part of the reflector, i.e. not the part of the reflector comprising the protrusion pattern, at least one spacer protrusion 29 that is used to space the light guide from the reflector. In accordance with FIGS. 2b and 2c, the spacer protrusion 29 may be located on the same side of the reflector that is adjacent to the light sources, such as LEDs. LEDs roughly emit light in a 90° cone in the light guide. The spacer protrusion 29 may be provided in between the LEDs as is indicated in FIG. 2c, thereby not enabling coupling out of the light emitted by the LEDs, since this light will not reach the spacer protrusion. The spacer protrusion 29 allows for mechanically supporting the light guide at the side closest to the light sources.

In an embodiment the other side of the reflector, i.e. the side being farthest away from the light source may also be provided with at least one spacer protrusion 29 enabling together with the alignment protrusion 28 alignment of the light guide to the reflector.

In an embodiment the alignment protrusion 28 or the spacer protrusion 29 is provided in a step shape comprising a seat (not shown) onto which the light guide in use may rest. Moreover, the step shape comprises a sidewall extending from the rest in a direction such as to prevent the light guide when in optical contact with the seat to move from its position in a sideways manner. As such the sidewall of the step shaped protrusion may used to align, such as positioning or centre, the light guide to the reflector.

In an embodiment horizontal alignment protrusion further functions as a spacer, onto which the diffuser may be attached, such that a gap is formed between the diffuser and the light guide, in use.

Since the reflector is made of one material having the same visual appearance, when no light is emitted using the light sources, and when viewing the diffuser the light reflected by the reflector will be visually uniform. This is contrary to the prior art solutions in which the sandblasted dots are seen through the diffuser. Accordingly, the light guide system according to some embodiments when observed from the diffuser side, when the light sources does not emit light, provides for a visually uniform structure free from the recognizable sandblasted dots of prior art.

To avoid friction, e.g. due to different thermal behavior, between the reflector and the light guide the reflector may be constructed from the same material as the light guide. However, different materials of the light guide and the reflector are equally possible.

The present invention is applicable in any application in which a uniform light surface is desired. For example, one such application may be display devices having ambient light capabilities. Moreover, such applications may benefit from the light guide system according to some embodiments since it allows for a more compact system.

The light guide according some embodiments is not limited only to flat light guides, but may also be applied on light guides having different shapes. For example, a round light guide is equally possible. In such a case the reflector is provided with a corresponding shape for enabling to become attached to the light guide.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A light guide system (20) for controlling out-coupling of light from a light guide, comprising
a light guide (21) configured to receive light from at least one light source (26), and emit spread light from a surface thereon,
a reflector (22) provided with a number of protrusions (23), wherein at least one protrusion of the reflector (22) is in optical contact with the light guide (21), in use.

2. The light guide system (20) according to claim 1, wherein said at least one protrusion is attached to the light guide (21) utilizing an adhesive, such as a glue.

3. The light guide system (20) according to claim 1, wherein said number of protrusions (23) forms a pattern having a gradually increasing distortion by means of gradually increased size of the protrusions along with the extension of the reflector (22).

4. The light guide system (20) according to claim 1, wherein said number of protrusions (23) forms a pattern having a gradually increasing distortion by means of gradually increased number of protrusions along with the extension of the reflector (22).

5. The light guide system (20) according to claim 1, wherein at least one protrusion of the number of protrusions has the shape of a peak or is conically shaped.

6. The light guide system (20) according to claim 1, wherein at least one protrusion of the number of protrusions has an elongated shape.

7. The light guide system (20) according to claim 1, further comprising a diffuser (24) provided at a distance from the light guide (21) at the side of the light guide (21) opposite the side of the reflector (22).

8. The light guide system (20) according to claim 1, wherein the reflector (22) is provided with at least one area (25), located in between the number of protrusions, which in use is not in optical contact with the light guide (21).

9. The light guide system (20) according to claim 1, wherein the reflector (22) is provided with a white paint, and acting as a diffuse reflector.

10. The light guide system (20) according to claim 1, wherein the reflector (22) is made of a plastic material.

11. The light guide system (20) according to claim 1, wherein the reflector (22) on the side facing the light guide (21) in use is provided with a foil.

12. The light guide system (20) according to claim 1, wherein the reflector (22) is created using injection moulding.

13. The light guide system (20) according to claim 1, wherein said at least one protrusion is attached to the light guide (21) utilizing thermal sealing.

14. The light guide system (20) according to claim 1, wherein the reflector (22) has a rectangular shape corresponding to a rectangular shape of the light guide (21).

15. The light guide system (20) according to claim 1, wherein the reflector (22) further comprises an alignment protrusion (28) or a spacer protrusion (29) for aligning the light guide (21) to the reflector (22).

16. The light guide system (20) according to claim 7, connected to a display device for displaying uniform ambient light based on image content of a video signal to be displayed on the display device.

17. A reflector (22) provided with a number of protrusions (23) forming a pattern of increasing distortion along at least a part of its extension thereof, wherein at least one protrusion of the reflector (22) when in optical contact with a light guide (21), is configured to couple out light travelling in the light guide.
